(19) United States
(12) Patent Application Publication
(10) Pub. No.: US 2006/0113745 A1
(43) Pub. Date: Jun. 1, 2006

(54) Device for fixing the front end assembly of a motorcycle with caster angle and adjustable ground caster angle

(76) Inventor: Jean-Paul Lagar, Saint-Juery (FR)

Correspondence Address: EGBERT LAW OFFICES, 412 MAIN STREET, 7TH FLOOR, HOUSTON, TX, 77002, US

(21) Appl. No.: 10/521,621

(22) PCT Filed: Jul. 16, 2003
(86) PCT No.: PCT/FR03/02240

§ 371 Date: Sep. 15, 2005

(30) Foreign Application Priority Data
Jul. 19, 2002 (FR) 0209176

(51) Int. Cl. B62K 21/00

(52) U.S. Cl. 280/279

(57) ABSTRACT

Device for fixing the front end assembly of a motorcycle includes an upper plate, a lower plate, a column shaft linking the two plates by enclosing the chassis column tube. The bearings originally mounted are replaced by an assembly of parts and the swivel joint element. The rotating elements are placed in the plate and the plate respectively to allow them to rotate on the column shaft locked in rotation by the part. The groove of the part and the cylindrical surfaces of parts with axis perpendicular to a median plane of the vehicle and passing through the center of the swivel joint allow the entire device to pivot about the axis to offset the column shaft with the axis of the tube thereby modifying the caster angle. The rotating element mounted in an oblong configuration enables the offset on the plate to be modified and by tilting about the axis and tilting of the plate about the axis enables the value of the ground caster distance and the inclination of the suspension element to be modified.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention involves a device for fixing the front end assembly of a motorcycle, allowing a modification of the parameters that define the dynamic qualities of the vehicle and notably the caster angle and the value of the ground caster distance.

### BACKGROUND OF THE INVENTION

For clarity of the present description, at first the current fashion most used by motorcycle manufacturers to create the fixation of the front end assembly will be explained in reference to FIG. 1, FIG. 2 and FIG. 3. FIG. 1 shows a drawing of the front end assembly of a motorcycle made in its median plane. FIG. 2 shows the same drawing but in a front view. FIG. 3 shows the detailed mounting of the steering column by a section I-I of FIG. 2 going along its axis of rotation.

It is known that on a motorcycle, the front wheel (1) is, in the largest majority of constructions, held by the front suspension element which is comprised of two parallel and telescopic legs (2a) and (2b), ensuring the functions of guiding, suspension and damping, and arranged on both sides of the wheel, on its axis of rotation and perpendicular to it. These two elements are connected at their upper part by two plates. An upper plate (3) is arranged at their upper end and a lower plate (4) is placed below the upper one and at a distance that allows the wheel to have freedom of movement in its oscillations. These two plates fit tightly around the steering column of the chassis.

The steering column is the front part of the chassis. It is comprised of a tube (5) in which are arranged, at each end, guide mechanisms (6a) and (6b) allowing the rotation of a shaft (7) that pass through them along the axis of the tube (5). This shaft (7) is called the “axis of the steering column.” It is affixed in the middle of the lower plate (4), passes through the steering column of the chassis in going into the guide mechanisms (6a) and (6b), then passes through the upper plate (3).

A rotation function is thus created between the chassis and the front end assembly. Using the handlebars (8) affixed onto the upper plate (3), the driver can change direction by rotating the front end assembly and thus the front wheel.

FIG. 3 shows a construction that is currently used, as a non-restrictive example, of a mounting of the steering column. Here, the guide mechanisms (6a) and (6b) are represented by the tapered roller bearings, mounted clamped into the receptacles of the column (5), in opposition and in an O. The nut (9) makes it possible to adjust the play necessary for the rotation of the bearings. The locknut (10) locks the assembly while preserving this functional play.

In order to give stability to the vehicle, the axis of rotation is inclined to the front in a manner so that the axis of rotation of the front wheel is in front of the steering column. The angle (A) formed by the perpendicular to the ground and the axis of rotation is called the “caster angle”. The distance (C) between the projection of the axis of rotation onto the ground and the point of contact of the wheel with the ground is called the “ground caster distance”.

It is very important in the study of a motorcycle to correctly choose the values of the caster angle and the ground caster distance in order to obtain the dynamic behavior of the vehicle that the majority of users desire to have for the specific use defined by the manufacturer's specifications. Thus, these values will be very different for a motorcycle planned, for example, for road usage where the caster angle is preferably between 20° and 24° and a motorcycle planned for all-terrain usage where the angle is preferably between 24° and 28 °.

Once the vehicle is made, these values can no longer be modified because the caster angle (A) is defined by the angle of the tube of the column (5) welded onto the chassis and the ground caster distance (C) is defined by the caster angle, the offset (B) made to the plates (3) and (4) and the possible offset (D) made to the fixation of the axle of the front wheel onto the legs of the suspension (2a) and (2b).

In the context of a usage that is more highly specialized and notably in competition, a large number of users want to optimize the values (A) and (C) as a function of their style of driving and the various accessories of their vehicle. To modify the ground caster distance (C), it is possible to replace the plates (3) and (4) with plates having a different offset (B) and to replace the suspension legs (2a) and (2b) with legs having a different offset (D). To do this, it is necessary to have as many plates and legs as there are values to attempt.

The modification of the caster angle (A) is made in some racing teams by using interchangeable rings that allow offsetting of the axle (7) relative to the column tube (5). The implementation of these rings makes necessary a significant and expensive modification of the tube (5) of the steering column used on competitive vehicles coming from mass-produced models. Moreover, each ring gives a fixed value of the angle (A) and the change of the ring requires the dismounting of the front end assembly and in particular, the plates (3) and (4). These significant interventions produce an equivalent reduction in the duration of the testing sessions that are limited in time.

### BRIEF SUMMARY OF THE INVENTION

The present invention proposes an assembly of upper and lower plates and column shaft which is able to be mounted easily on the column (5) of the motorcycle chassis used by the manufacturers in mass-production, which offers the particularity of being able to make the caster angle (A) vary more or less on the order of 1° to 3° and the offset (B) in an independent manner on the upper and lower plates. These adjustment modifications can be made quickly without dismounting the front end assembly.

### BRIEF DESCRIPTION OF THE SEVERAL VIEWS OF THE DRAWINGS

More specifically, and in referring to the attached drawings, given as non-restrictive examples, where the different preferred embodiments of the invention are shown,

in addition to FIG. 1,

FIG. 2 and

FIG. 3 described above:

FIG. 4 is a section I-I of FIG. 2 of the mounting of the steering column that allows unique regulation of the caster angle (A), in a middle position.

FIG. 5 is a section II-II of FIG. 4.

FIG. 6 is a section identical to FIG. 4 but in an extreme adjustment position.

FIG. 7 is a section according to III-III of FIG. 4.

FIG. 8 is the enlarged detail IV of the surfaces (20) and (21).

FIG. 9 is a section I-I of FIG. 2 of the mounting of the steering column that allows the regulation of the caster angle (A) and the regulation of the offset (B) unique to the upper plate, in a middle position.

FIG. 10 is a section V-V of FIG. 9.

FIG. 11 is a section identical to FIG. 9 but in an extreme position for adjustment of the offset on the upper plate.

FIG. 12 is a section along VI-VI of FIG. 9.

FIG. 13 is a section along VII-VII of FIG. 9.

FIG. 14 is a drawing similar to that of FIG. 1 but with the adjustment of FIG. 11.

FIG. 15 is a section I-I of FIG. 2 of the mounting of the steering column that allows regulation of the caster angle (A) and regulation of the offset (B) on the two upper and lower plates, in the middle position.

FIG. 16 is a section VIII-VIII of FIG. 15.

FIG. 17 is a section I-I of FIG. 2 of the mounting of the steering column that allows the exclusive regulation of the caster angle (A), in a middle position and mounted in a manner that is inverted from the mounting of FIG. 4.

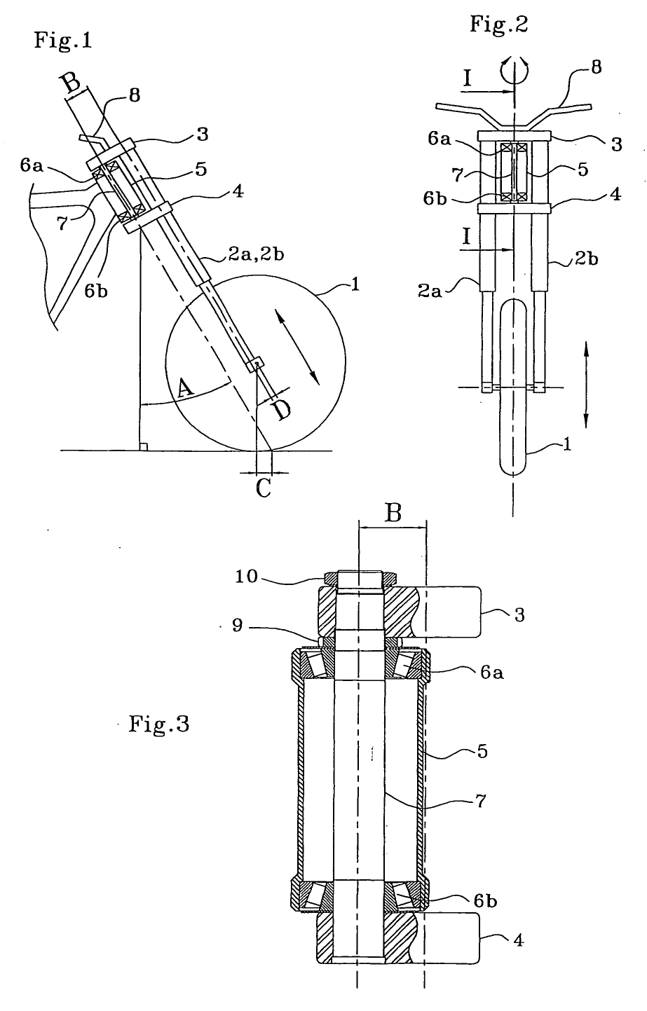

### DETAILED DESCRIPTION OF THE INVENTION

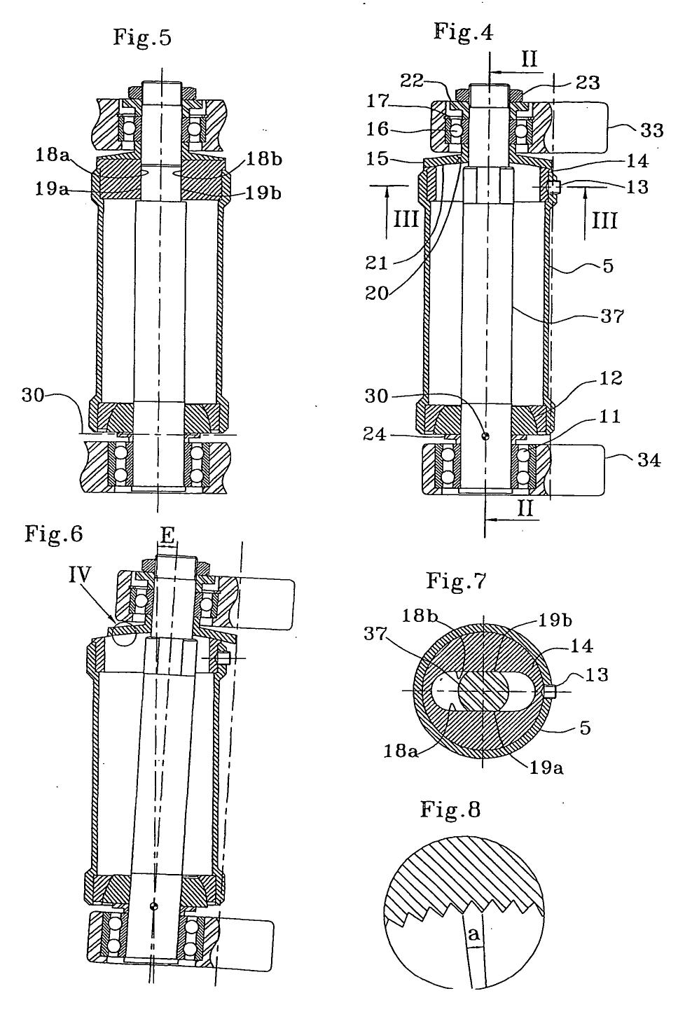

FIG. 4, FIG. 5, FIG. 6 and FIG. 7 show, as a non-restrictive example, a construction of a device according to the invention but only allowing the exclusive regulation of the caster angle. In this mounting, the column tube (5) of the chassis is kept but the guide elements (6a) and (6b) of FIG. 3, ensuring the rotation of the front end assembly relative to the chassis, are replaced respectively by the elements (16) and (11) placed respectively in the upper plate (33) and lower plate (34). In this way, the rotation of the front end assembly is preserved in spite of the blocking of rotation of the axle of the column (37).

The axle (37) passes through the guide element (11), shown here, as a non-restrictive example, as a double row ball bearing and affixed in an appropriate manner in the plate (34), as (non-restrictive example) a clamped fitting and machined support, in a manner so as to support the axial loads directed to the top and transmitted by the front end assembly through the plate (34), through an angular contact bearing (12) arranged in place of the guide element (6b) of FIG. 3 in the tube (5), in an appropriate manner, and able to support the axial forces transmitted by the element (11).

A spacer (24) can be arranged between the elements (11) and (12) in order to guarantee a minimum distance between the top of the plate (34) and the bottom of the tube (5) in order to allow the tilting movement of the plate (34). This spacer (24) can also be provided with any means of sealing in order to protect the elements (11) and (12).

In its upper part, the axle (37) goes through a guide part (14) affixed instead of and in place of the element (6a) of FIG. 3 in the tube (5), in an appropriate manner and as a non-restrictive example, by tight fitting and locking screw (13) preventing any rotational movement of the part (14) in the tube (5). The part (14) has a groove with parallel sides (18a) and (18b). The axis of this groove must be arranged in the plane of FIG. 4, i.e. more precisely, in the plane of FIG. 1 which is the median plane of the vehicle and the plane that defines the caster angle (A).

On the axle (37), two planar surfaces having parallel sides (19a) and (19b) are made with dimensions that allow them to slide without play on the respective sides (18a) and (18b) of the groove of the part (14).

The upper surface (20) of the part (14) is a cylindrical portion of the axis (30) perpendicular to the sides (18a) and (18b) of the groove and passing through the center of rotation of the bearing (12). The part (15) arranged above the part (14) has a lower cylindrical surface (21) combined with the surface (20) in a manner so that the part (15) can slide on the part (14) while rotating around the axle (30) of the cylindrical surfaces. The part (15) is opened in its middle and perpendicularly to the axle (30) of the cylindrical surface in order to allow the passage of the top of the axis of the column (37).

The axle (37) then goes through the guide element (16), represented here as a non-restrictive example by a deep groove ball bearing, affixed in an appropriate manner in the upper plate (33) and notably by a clamped fitting and retaining circlips (17), goes through the spacer (22) on which a locknut (23) rests.

When the nut (23) is not being clamped, it is possible to rotate all of the front end assembly around the axle (30), guided by the sliding of the sides (19a) and (19b) of the axle (37) on the sides (18a) and (18b) of the groove of part (14) and the sliding of the cylindrical surface (21) of the part (15) on the combined surface (20) of the part (14). Once positioned at the value (E) of FIG. 6 corresponding to the desired modification value of the caster angle (A), the nut (23) is clamped in a manner appropriate for locking this position by the adhesion of the surfaces (20) and (21).

To ensure an effective locking and prevent any risk of sliding of the surface (21) on the surface (20) subjected to significant stresses transmitted by the front end assembly in the braking phase or the strong compression of the suspension, it is necessary to tighten the nut (23) very strongly, on the order of 10 to 15 m.kg.

In order to prevent a tightening that is too sizeable and ensure perfect locking, it is advantageous to create a locking using a stop and not by pure adhesion by creating small grooves on the surfaces so that the surface (21) engages perfectly on the surface (20) as shown in FIG. 8. These grooves are made on the lines parallel to the axle (30) of the cylindrical surfaces (20) and (21). They are shown here as non-restrictive examples in a triangular section and allow an angular adjustment by steps (a) on the order of 0.1° to 0.50 °.

It should be noted that the device mounted in an inverted manner from that of FIG. 4 also makes it possible to regulate the caster angle (A). The adjustment nut (23) can also and independently be positioned beneath the plate (34).

FIG. 17 shows such a mounting where the swivel joint element (12) is mounted in place of the upper guide element (6a), and the guide part (14) in place of the lower guide element (6b). The part (15) is then found beneath the part (14) and their respective cylindrical surfaces (21) and (20) always have their axis common with the swiveling center (30) of the element (12). Here, the axle of the column (37) is mounted in the reverse direction of FIG. 4, and the locknut (23) is positioned below the plate (34). The nut (23) is supported on the spacer (722) fitted to the dimensions of the bearing (11) and the axle (37). The plate (73), the bearing (716) and the spacer (724) are modified to the inverted mounting.

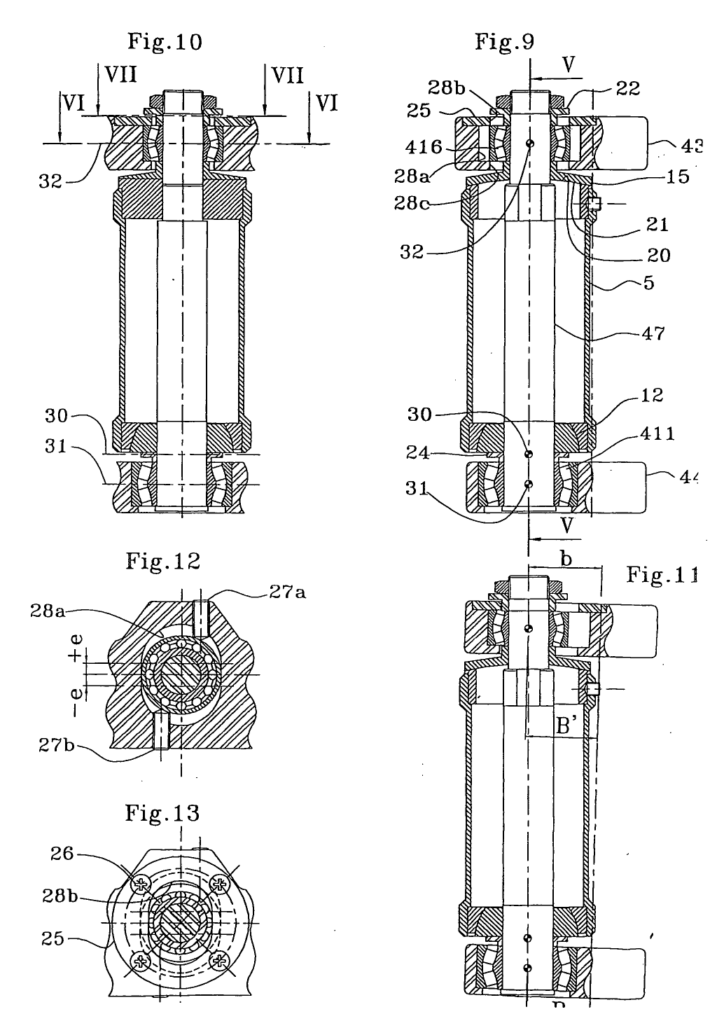

FIG. 9, FIG. 10, FIG. 11, FIG. 12 and FIG. 13 show, as a non-restrictive example, a construction of a device according to the invention and of the same type as that of FIG. 4 and FIG. 5 onto which the independent adjustment of the offset (B) on the upper plate (43) has been added.

In this construction, the deep groove ball bearings (11) and (16) of FIG. 4 are replaced respectively and as a non-restrictive example, with the spherical roller bearings (411) and (416). The bearing (411) is mounted in an appropriate manner on the lower plate (44) with, as a non-restrictive example, a clamped fitting and supported on the plate (44) in a manner so as to effectively support the axial stresses transmitted by the front end assembly.

The bearing (416) is affixed on the upper plate (43) in a receptacle (28a) having an angular shape and dimension allowing displacement, without lateral play, of the bearing (416) over a distance of (+e) or (−e). The axle of this angular shape (28a), defining the direction of displacement of the bearing (416), is contained in the plane of FIG. 9 which is the median plane of the vehicle, as represented in FIG. 12 and FIG. 13. A locking part (25) limits the vertical movement of the bearing (416). This part (25) is held on the plate (43) by, as a non-restrictive example, four screws (26) in a manner so that the movement of the bearing occurs without vertical play. An opening having an oblong shape (28b) is made in the center of the part (25) in a manner so as to allow displacement with play of the spacer (22). A similar oblong shape (28c) is made in the bottom of the plate (43) in order to allow the displacement, with play, of the collar of the part (15). The two shapes (28b) and (28c) have their axes contained also in the median plane of the vehicle.

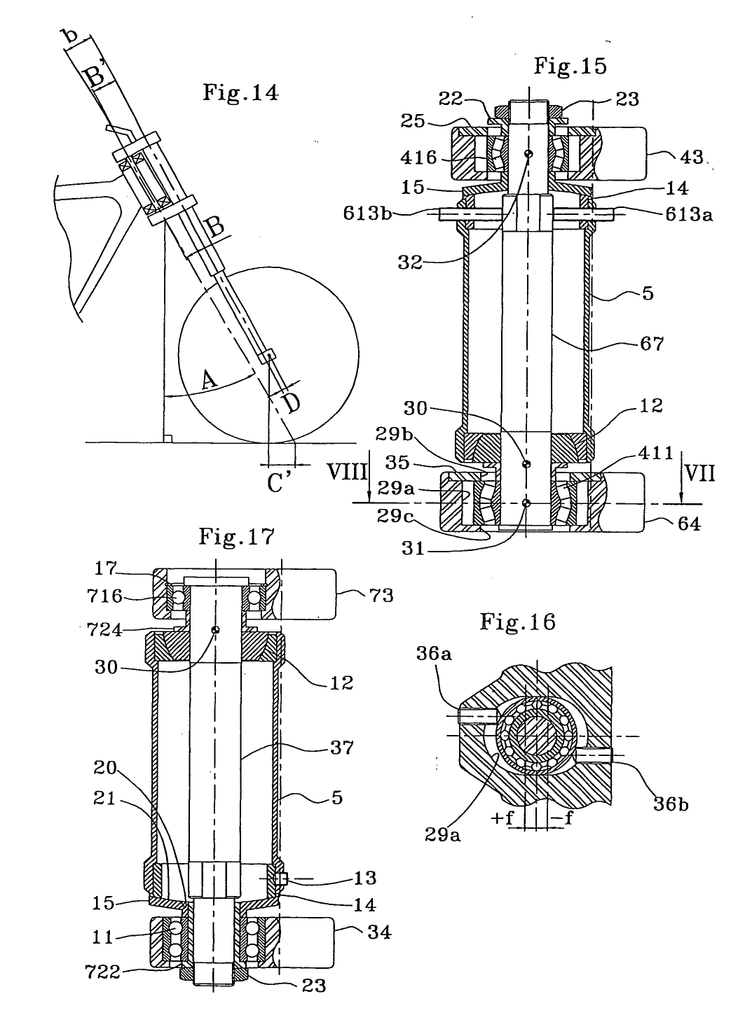

As a non-restrictive example, two adjustment screws (27a) and (27b) make it possible to displace and position the bearing (416) at a position (B′) between (B−e) and (B+e). The new value (B′) of the offset of the upper plate (43) linked to the offset (B) de the lower plate (44) causes an angle (b) between the axis of rotation of the axis of the column (47) and the axis of the suspension legs (2a) and (2b). This incline is made possible by the tilting of the plates (43) and (44) over respectively the bearing axes (32) and (31) of the bearings (416) and (411). In FIG. 14 it is noted that the incline (b) due to the offsets (B′) and (B) causes a modification of the ground caster distance (C′) different from the value (C) of FIG. 1.

FIG. 15 and FIG. 16 show, as a non-restrictive example, a third construction according to the invention and of the same type as that of FIG. 9 and FIG. 10, to which the independent adjustment of the offset (B) on the lower plate (64) has been added.

In this construction, the bearing (411) is mounted on the plate (64) in a manner identical to the mounting of the bearing (416) on the plate (43). Thus the part (25), the shapes (28a), (28b) and (28c) of the mounting of the upper plate (43) are respectively the part (35) and the shapes (29a), (29b) and (29c). Two screws (36a) and (36b) similar to the screws (27a) and (27b) of the plate (43) also allow the displacement and the positioning of the bearing (411) in the plate (64) and at a position between (B−f) and (B+f) with (f) representing the maximum displacement of the bearing (411) more or less in the plate (64) relative to its middle position.

Also appearing on the mounting of FIG. 15, as a non-restrictive example, are two screws (613a) and (613b) which allow the displacement and the positioning of the axle (67) in rotation on the axle (30) during the period of adjustment of the caster angle. This mounting can be used in replacement or with the grooves of the surfaces (20) and (21) FIG. 8. These two screws screw into the tapped holes made, as a non-restrictive example, through parts (5) and (14), after having correctly positioned the part (14) in the tube (5).

1. Device for fixing the a front end assembly of a motorcycle, said device comprising:
an upper plate, a lower plate, a column shaft connecting the lower plate and the upper plate by going through a column tube of a chassis,
further comprising: a guide part and a swivel joint element placed respectively or inversely in upper and lower receptacles of guide elements of the column tube and placed by manufacturers in order to allow rotation of the front end assembly, the two elements being passed through by the column shaft, the rotating elements and being placed respectively in the lower plate and upper plate in order to permit rotation of these plates on the column shaft immobilized in rotation relative to the tube (5), and
a part sliding on the guide part while holding the axle which goes through said guide part, being placed between the guide part and the upper plate, an assembly thereof of the front end assembly being comprised of two equipped plates, the part, and the column shaft, being able to tilt by sliding of the part holding the axle, on the part united with the tube and guiding the axle in movement in a median plane of the motorcycle and around the axis of rotation perpendicular to the median plane of the motorcycle and goes through a bearing center of the swivel joint element.

2. Device according to claim 1, wherein said upper surface of the guide part and the lower surface of the part are cylindrical surfaces of the axis perpendicular to the median plane of the motorcycle and going through the center of rotation of the swivel joint element.

3. Device according to claim 1, further comprising a groove having parallel sides in the guide part so that the axle of this groove is contained in the median plane of the motorcycle and that the column shaft is slidable without play along said groove by, an intermediary of the two flat surfaces on the shaft.

4. Device according to claim 1, further comprising an element preventing rotation of the guide part relative to the tube.

5. Device according to claim 1, further comprising a nut positioned at either of the two ends of the column shaft, the second end having a stop, locking a position of the shaft at the desired angular value while adhesion of the cylindrical surface of the part on the cylindrical surface of the guide part by pressure created by the compression of the parts between said nut and stop of the axle.

6. Device according to claim 5, further comprising, on the cylindrical surface of the part, small grooves over lines parallel to the axis of the surface, engageable perfectly with the combined grooves made on the surface of the guide part, thus an angular adjustment of the axle relative to the tube by steps of value and a locking into position by positive locking.

7. Device according to claim 5, further comprising two opposing threaded holes having an axis contained in the median plane of the motorcycle through the guide part or the tube or both, allowing two screws to adjust and lock the angular position of the column shaft relative to the tube axis.

8. Device according to claim 1, wherein the rotating elements is fixed by a part on the upper plate in a receptacle having an oblong shape, with an axis contained in the median plane of the motorcycle, able to allow sliding without play and to allow the positioning of the rotating element using adjustment screws in order to modify the offset on the upper plate to a value (B′) between (B−e) and (B+e).

9. Device according to claim 1, wherein the rotating element is fixed by a part on the lower plate in a receptacle having an oblong shape, with an axis contained in the median plane of the motorcycle, enabling the rotating element to be slid without play and enabling positioning thereof using the adjustment screws in order to modify the offset (B) on the lower plate to a value (B″) between (B−f) and (B+f).

10. Device according to claim 8, wherein rotating elements respectively placed in the upper plate and lower plate have a freedom of bearing rotation around the respective axes swinging of the upper plate and lower plate around these axes.
